(19) United States
(12) Patent Application Publication
(10) Pub. No.: US 2013/0173381 A1
(43) Pub. Date: Jul. 4, 2013

(54) CLOUD-RENDERED HIGH-QUALITY ADVERTISEMENT FRAME

(71) Applicant: Gface GmbH, Frankfurt/Main (DE)

(72) Inventor: Cevat Yerli, Frankfurt/Main (DE)

(73) Assignee: GFACE GMBH, Frankfurt/Main (DE)

(21) Appl. No.: 13/729,001

(22) Filed: Dec. 27, 2012

Related U.S. Application Data
(60) Provisional application No. 61/581,213, filed on Dec. 29, 2011.

(51) Int. Cl. G06Q 30/02

(52) U.S. Cl. CPC G06Q 30/0277
USPC 705/14.43; 705/14.73; 705/14.68

(57) ABSTRACT

A network-based system of providing an advertisement stream to at least one user, the system including a computing cloud configured to receive different media data from a plurality of advertisement data sources and generate from said media data at least one advertisement data stream to be provided to at least one remote user; a network entity configured to transmit said at least one advertisement data stream to a user device of the at least one user; the user device configured to display the content of the at least one advertisement data stream within a network-based online presentation.

### CROSS-REFERENCE TO RELATED APPLICATION

This application claims the benefit of U.S. Provisional Patent Application No. 61/581,213, filed Dec. 29, 2011, the disclosure of which is incorporated by reference herein in its entirety.

### FIELD

The present disclosure relates to a network-based system and to a method of providing an advertisement stream to at least one user.

### BACKGROUND

There are known network-based systems and methods for providing advertisement streams to users of a network. Such a system is described in U.S. Pat. No. 7,788,687 B.

There are also known network-based systems and methods for providing cloud computing to a plurality of clients. Such a system is described in U.S. Pre-Grant Publication No. 2010/0257252 A1.

The content of a current dynamic advertisement frame is requested from the web page running in a browser window. Any rendering of the content is done on the local computer, thus the actual quality depends both on its installed plug-ins and on its performance. A content provider can never be sure if the intended quality is actually presented to the customer.

Even more importantly, the advertisement impression usually depends on the user to request a web page before a new advertisement is displayed.

### SUMMARY

The present disclosure relates to a network-based system and to a method of providing a live stream containing advertisement data inside a container or frame that can be placed on web pages. Moreover, the disclosure relates to a system and to a method that provides advertisement by a content stream which is rendered, updated, and programmed in a rendering cloud. Thus, a live advertisement stream can be provided that refreshes and updates the advertisement independent from the refresh of the web page and hence delivers highest quality real-time rendering of advertisement streaming to any computer or other media device, such as a web-enabled cell phone or MP3 player.

According to a first aspect of the disclosure there is described a network-based system of providing an advertisement stream to at least one user, the system comprising:
a computing cloud configured to receive different media data from a plurality of advertisement data sources (such as ad servers) and generate from said media data at least one advertisement data stream to be provided to at least one remote user;
a network entity (e.g., at least one ad server) configured to transmit said at least one advertisement data stream to a user device of the at least one user;
the user device configured to display the content of the at least one advertisement data stream within a network-based online presentation, in particular within a web page and/or a game presentation.

According to another aspect of the disclosure there is described a method of providing an advertisement stream to at least one user within a network-based system, the method comprising the steps of:
receiving a request to provide and/or update an advertisement stream;
requesting and receiving different media data from a plurality of advertisement data sources and generating from said media data at least one advertisement data stream to be provided to at least one remote user;
transmitting said at least one advertisement data stream to a user device of the at least one user; and
displaying the content of the at least one advertisement data stream within a network-based online presentation, in particular within a web page and/or a game presentation.

The described system and method offers a refreshed rendering of the stream on the ad server in real-time, dynamically updating the ad programming and improving its acceptance quality.

The system and method may generate from any visual or audio advertisement content (static images, 2D and 3D video, audio, applications, and so on) a combined media on a rendering cloud that minimizes the performance needs on the client device. The renderer (rendering cloud) is able to combine different content sources into one stream and can do so individually for multiple users. Via feedback from the user, the ad stream can be updated according to the user's characteristics, interests, or demands: the feedback can be both explicit (such as user interface (UI) input, including mouse clicks, or keyword(s)) and implicit (such as profile data, demographic data, and/or collected interests). The ad stream can be updated independently from any update or refresh of the web page the stream is embedded in, since its refreshed state is determined on a separate server and provided, through the rendering cloud, seamlessly in the stream. A backlog of items to serve to a user may be stored for every user connected to the service. These backlogs can be, but do not have to be, persistent over time, e.g., the cloud server stores this backlog data for a later time when the user logs in, in the future.

The network entity may comprise at least one ad server and may schedule the transmission of said at least one advertisement data stream to the user device of the at least one user. The network entity may schedule the transmission of said at least one advertisement data stream independently from any update or refresh of the network-based online presentation on the device of the at least one user.

Moreover, the plurality of advertisement data sources and/or the network entity (ad servers) may update the generation of the at least one advertisement data stream depending on feedback from the at least one user and/or the device. The feedback from the at least one user and/or the device can include explicit input, in particular input made at the user interface, such as mouse clicks, keyboard input, and/or keyword input. The feedback may also include implicit input, in particular user profile data, demographic data, and/or collected data about users' interests.

The plurality of advertisement data sources and/or the network entity can store backlog data, in particular, a history of content streamed. Further to this, the plurality of advertisement data sources and/or the network entity can continuously update the stored backlog data.

### DESCRIPTION OF THE DRAWINGS

Further features and advantages of the present disclosure, as well as the structure and operation of various illustrative embodiments of the present disclosure, are described in detail below with reference to the accompanying schematic drawings, wherein:

FIG. 1 shows a system structure for an embodiment of a system according to the present disclosure.

FIG. 2 shows a flow chart for implementing said embodiment of the present disclosure.

### DETAILED DESCRIPTION

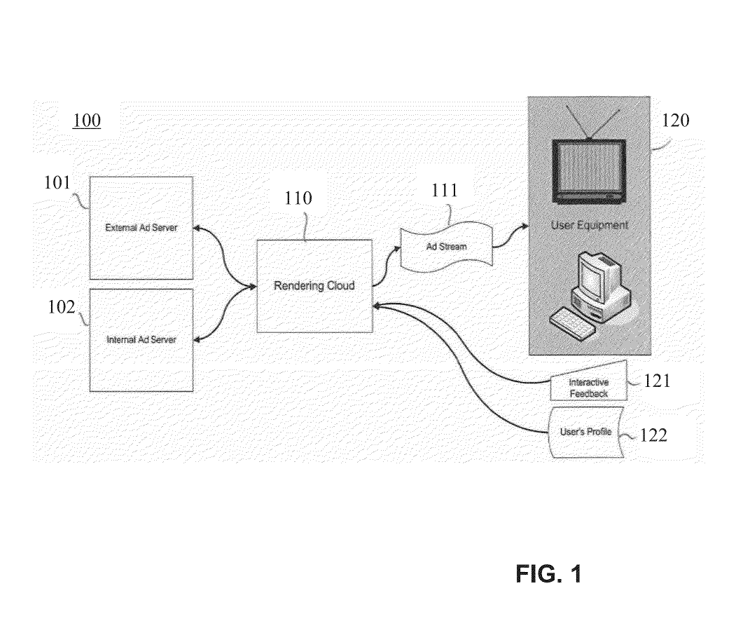

As shown in FIG. 1, the described system 100 uses a rendering cloud 110, providing an optionally interactive ad stream 111 to user equipment or client device 120. The ad stream 111 is comprised of any kind of media (e.g., video, banner, text, non-animated or animated 2D and 3D graphics, audio) delivered on the user's equipment or client device 120 (such as a PC, a media player, a television, or any other kind of media equipment). The rendering cloud 110 gets its content (e.g., videos, banners, text, graphic, audio) from internal or external sources such as ad servers 101 and 102. On request of either the web page or the user (see feedback 121), the rendering cloud 110 computes the individual combined stream content. It may be a combined content, i.e., a cloud-rendered single image possibly containing multiple advertisements in one data transfer. If it is a continuous stream, it can either be multiple streams overlaying each other, or one stream following another. With the term “ad stream,” the logical item of the multimedia stream is described that is generated in the rendering cloud and then transferred to the user's equipment.

Further to this, the rendering cloud 110 has advertisement programming that is not request-based, but logic-based. This can include time, user input, and keywords to define the output of the stream. For example, the website may be static, but the ad stream may update its advertisement live and independently from the website's update mechanics. The rendering cloud 110 schedules these advertisements by the use of keywords entered by the user, analysis of user information (see user's profile 122) or pre-defined ad server logic.

Internal servers are those running the web page that is being browsed—these will often showcase other content/products from that web page. External servers are controlled by an external ad agency or agencies, or other advertisement deliverers. There is no limit to the number of servers that can feed the ad stream with external content.

Described embodiments also provide user input and interaction:

Ads can include (but are not limited to) still images, videos, trailers, game demos, fee-to-play games, and or any other interactive content. Content also will be composited together on the renderer. The user can be invited to click on the ad where appropriate, with examples including playing a game demo, registering interest in either the product or the ad, or simply buying the product. These feedback actions (i.e., mouse clicks) are transferred to the rendering cloud in order to be processed (or “actioned”), and the ad stream then changes to reflect the new information. When the user interacts with the ad stream, it will also send the user's profile back to the server via the rendering cloud, allowing easier transactions, where applicable, and enabling the server to select ads that will appeal to the user in the future.

As an example, the following use case relating to a free game demo will be described here:

If the user plays a game demo, the rendering cloud will record and process (or “action”) any data (e.g., input via a mouse, keyboard, or game controller) that the user enters to play the game. At the end of the demo, the user could be offered the chance to buy the game—if the user accepts the offer, the ad stream will respond, changing from a promotion of the game and instead reflecting information that is relevant to the user, now that the user is buying it. This could include a download screen or a form in which he can enter his bank and/or shipping details. However, should the user decline to buy the game, the user may be asked for reasons why the user elected not to buy the game, allowing the system to discern what about the game or offer that the user did not like and therefore allow the system to select another game that will better appeal to the user.

Similarly, should the system play the same ad on a set number of occasions and it is ignored by the same user each time, the system can ask the user if the user is interested in that content. Should the user say no, the system will know to stop playing the ad and select another, and can also use that data to better target the ad stream in future.

Described embodiments also provide the feature of ad selection:

Ad content can be selected in one of two ways to better appeal to the user. If the user is logged in to a website for which he has a profile (i.e., user can be identified by the system), it will select ads that will interest the user based on the user's profile and past activity. Alternatively, if the user is not logged in (or the system does not have any specific information about him), ads can be selected at random, but will more likely be presented based on the web page the user is browsing or the search terms the user has entered. In this case, ads can be targeted based on a portrait of the typical user of that web page or those search terms and could even be refined by the system with reference to the profiles and past activity of users who have browsed or searched for that same thing. After the stream starts, the system can begin collecting data about the user, thus creating a temporary profile by requesting feedback from the user about the displayed content to improve the targeting of content towards that user.

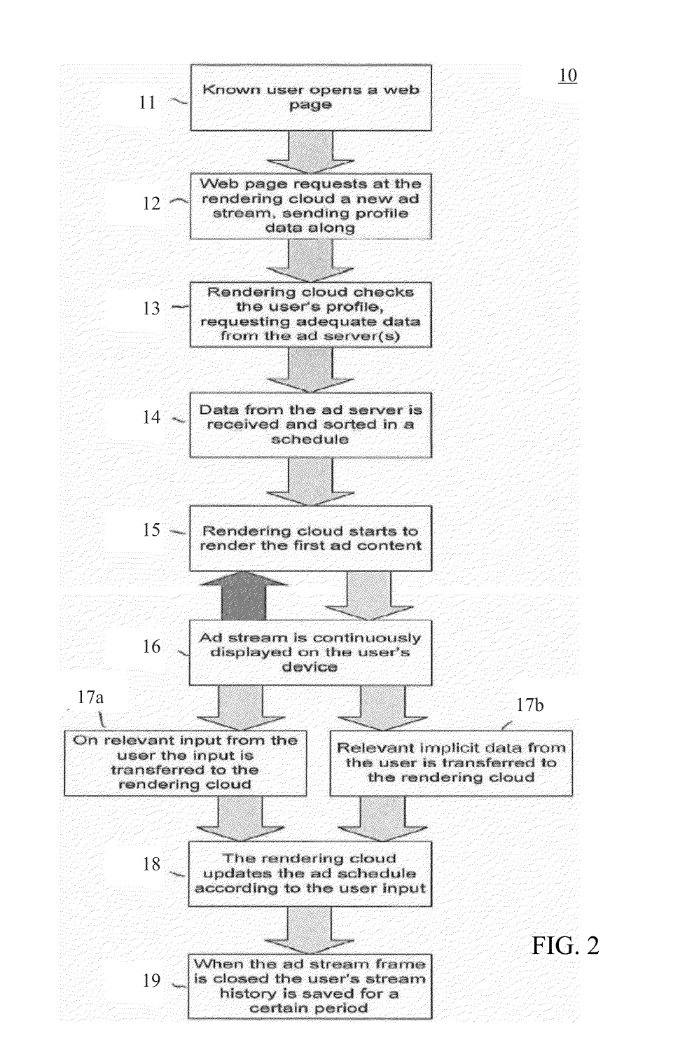

In FIG. 2, a flowchart of the method of providing an advertisement stream to at least one user within the network-based system is shown. The method 10 comprises the following steps (11-19):

In a first step 11, the user browses and opens a web page on the display of his/her device. Then, in step 12, the web page request will also reach the rendering cloud (see 110 in FIG. 1); the request will be sent along with profile data from the user's profile (see 121 in FIG. 1). In a next step 13, the cloud computers will check the user's profile and then will request adequate data from the data sources (see 101 and 102 in FIG. 1), i.e., from internal and/or external ad servers. In a further step 14, these data are received and sorted in a schedule. Then the rendering cloud starts to render the first ad content (see step 15). In a next step 16, the ad stream is continuously displayed on the user's device (e.g., PC, laptop, smartphone). Then in step 17a, any relevant input (explicit input) from the user is transferred to the rendering cloud. Alternatively, or in parallel, the step 17b is performed to transfer relevant implicit input data from the user to the cloud. Afterwards, in step 18, the cloud updates the ad schedule according to the received user input(s). Finally, in step 19, the history of the user's ad stream is saved when the ad stream frame will be closed.

The method basically performs the receiving of a request to provide and/or update an advertisement stream (step 12); the requesting and receiving of different media data from a plurality of advertisement data sources and generating from said media data at least one advertisement data stream to be provided to at least one remote user (steps 13-15); the transmitting of the at least one advertisement data stream to a user device of the at least one user; and the displaying of the content of the at least one advertisement data stream within a network-based online presentation (step 16).

Within the method of providing the ad stream, there may be implemented the checking of control data, in particular of the user's profile data, feedback data, and/or backlog data for generating and/or scheduling the at least one advertisement data stream (step 13); the storing and/or updating of backlog data, in particular the history of content streamed (step 19); and the updating the generating of the at least one advertisement data stream depending on feedback from the at least one user and/or from the device (step 18).

When referring to steps 13-15, the details of the rendering of the ad stream may be as follows:

The ad stream is constructed in real-time, taking the profile and other data of the user into account. Based on the data, the server creates a backlog of ad items to play, sorting them from highest to lowest probability to fit the recipient's profile. This backlog is updated in real time to include the latest ads that are stored on the server.

Depending on the available content, the ad stream can also include free content such as games, videos, news, and so on. The selected ads are then rendered as a video/audio stream, using one item after the other of the backlog of items that might suit the user.

One very important aspect of the present disclosure is that although different sources can be rendered and streamed, the main advantage is to combine these single sources into one stream, thus having in one video stream a composite of a game running, while an animated advertisement runs above the game window and a still picture ad banner is placed on the left side of the game window.

The renderer is able to combine separate content from the storage servers to a new composite content or image. For example, the renderer could fetch single still images stored on the server and create a composite image for the stream, in which one image serves as a background while others are animated in front of it. Additionally, text can be added as well. Still images are also transferred as a video stream, although the video compression recognizes if no changes are applied to the image and will save bandwidth automatically.

The renderer can also combine more than one video into the ad stream in different ways, for example, by presenting two videos in an arrangement such as side-by-side, picture-in-picture, above-and-below, or in any other arrangement.

Described embodiments also provide changes in the ad stream as follows:

As soon as the user inputs feedback, the backlog can be updated and the render schedule will reflect the changes. This is called explicit input from the user (e.g., entered keywords, answered questions). Any implicit input collected by the page, the renderer, or the browser (e.g., the behavior of the user or his profile) will also be used to update the ad stream.

On the user's device, the ad stream will be displayed inside a frame in the browser application. The update of the ad stream is independent from other content displayed in the browser.

When referring to step 19, the details of closing the ad stream may be as follows:

Upon closing the frame on the user's device, the stream will stop being rendered. The generated history of content streamed will be stored for a certain period of time to allow the user to pick up the content stream later.

Any relevant changes in the user's behavior that will improve the targeting of the user will be added to the user's profile.

While illustrative embodiments have been illustrated and described, it will be appreciated that various changes can be made therein without departing from the spirit and scope of the invention.

The embodiments of the invention in which an exclusive property or privilege is claimed are defined as follows:

1. A network-based system of providing an advertisement stream to at least one user, the system comprising:
a computing cloud configured to receive different media data from a plurality of advertisement data sources and generate from said media data at least one advertisement data stream to be provided to at least one remote user;
a network entity configured to transmit said at least one advertisement data stream to a user device of the at least one user; and
the user device configured to display the content of the at least one advertisement data stream within a network-based online presentation.

2. The network-based system of claim 1, wherein the network-based online presentation is a web page and/or a presentation of a game.

3. The network-based system of claim 1, wherein the different media data comprises video, audio, still images, and/or graphics.

4. The network-based system of claim 1, wherein the plurality of advertisement data sources comprises at least one ad server.

5. The network-based system of claim 1, wherein the network entity comprises at least one ad server.

6. The network-based system of claim 1, wherein the network entity is configured to schedule the transmission of said at least one advertisement data stream to the user device of the at least one user.

7. The network-based system of claim 6, wherein the network entity is configured to schedule the transmission of said at least one advertisement data stream independently from any update or refresh of the network-based online presentation on the device of the at least one user.

8. The network-based system of claim 6, wherein the plurality of advertisement data sources and/or the network entity is configured to update the generation of the at least one advertisement data stream depending on feedback from the at least one user and/or the device.

9. The network-based system of claim 8, wherein the feedback from the at least one user and/or the device comprises explicit input.

10. The network-based system of claim 9, wherein the explicit input comprises mouse clicks, keyboard input, and/or keyword input.

11. The network-based system of claim 8, wherein the feedback from the at least one user and/or the device comprises implicit input.

12. The network-based system of claim 11, wherein the implcit input comprises user profile data, demographic data, and/or collected data about the user's interests.

13. The network-based system of claim 1, wherein the plurality of advertisement data sources and/or the network entity stores backlog data.

14. The network-based system of claim 13, wherein the backlog data comprises history of content streamed.

15. The network-based system of claim 13, wherein the plurality of advertisement data sources and/or the network entity is configured to continuously update the stored backlog data.

16. A method of providing an advertisement stream to at least one user within a network-based system, the method comprising the steps of:
receiving a request to provide and/or update an advertisement stream;
requesting and receiving different media data from a plurality of advertisement data sources;
generating from said media data at least one advertisement data stream to be provided to at least one remote user;
transmitting said at least one advertisement data stream to a user device of the at least one user; and
displaying the content of the at least one advertisement data stream within a network-based online presentation.

17. The method of claim 16, further comprising at least one of the following steps:
checking control data for generating and/or scheduling the at least one advertisement data stream;
storing and/or updating backlog data; and
updating generation of the at least one advertisement data stream depending on feedback from the at least one user and/or the device.

18. The method of claim 17, wherein the control data comprises a user's profile data, feedback data, and/or backlog data.

19. The method of claim 17, wherein the backlog data comprises history of content streamed.
